(19) United States
(12) Patent Application Publication
(10) Pub. No.: US 2017/0054312 A1
(43) Pub. Date: Feb. 23, 2017

(54) ELECTRONIC DEVICE AND CORD STORAGE APPARATUS

(71) Applicants: Brock Steven Kuchynka, Glendale, AZ (US); Miranda Christine Kuchynka, Glendale, AZ (US)

(72) Inventors: Brock Steven Kuchynka, Glendale, AZ (US); Miranda Christine Kuchynka, Glendale, AZ (US)

(21) Appl. No.: 15/138,039

(22) Filed: Apr. 25, 2016

Related U.S. Application Data
(60) Provisional application No. 62/120,709, filed on Feb. 25, 2015.

(51) Int. Cl. H02J 7/00; F16M 13/02; F16M 11/22; A45C 11/00; F16M 11/10

(52) U.S. Cl. CPC H02J 7/0044; A45C 11/00; F16M 11/10; F16M 11/22; F16M 13/022; A45C 2011/002; A45C 2011/003

(57) ABSTRACT

An electronic device storage apparatus to secure an electronic device and a corresponding charging member is disposed between a pair of adjacent furniture members or coupled to a wall. The storage apparatus includes a base member with an upper member and a lower member to create a main cavity to secure the electronic device, the lower member having at least one opening to receive a head portion of the charging member to permit the head portion to be coupled to the secured electronic device, a first panel pivotably mounted to the lower member and designed to enclose the base member's main cavity, and a second panel pivotably mounted to the lower member. The second panel is disposed between the pair of adjacent furniture members or detachably coupled to the wall.

### RELATED APPLICATION

The application claims priority to provisional patent application U.S. Ser. No. 62/120,709 filed on Feb. 25, 2015, the entire contents of which is herein incorporated by reference.

### BACKGROUND

The embodiments herein relate generally to storage devices for electronic devices.

The majority of individuals own several electronic devices such as mobile phones, smartphones, tablets, phablets, baby monitors, or the like. These devices comprise batteries that are required to be recharged on a regular basis to enable the devices to operate. Several room locations near a bed or furniture make it difficult for individuals to access, operate and/or charge their electronic devices. In these locations, individuals typically place the electronic device and/or charging cord on the floor or on an end table. This causes individuals to awkwardly reach for the phone and/or charging cord on the floor or end table, which can cause the individuals to experience discomfort or suffer injuries to their back, arms, or the like. Several electronic device storage units exist, but they do not secure the charging cord together with the electronic device. Therefore, these storage devices often cause individuals to drop, lose or misplace the charging cord.

As such, there exists a need in the industry for a storage apparatus that conveniently stores an electronic device and charging cord, which addresses the limitations of the prior art. There exists a further need for the storage apparatus to be either secured to a flat surface such as a wall or a furniture member such as a bed mattress.

### SUMMARY

An electronic device storage apparatus to secure an electronic device and a corresponding charging member therein is provided. The storage apparatus is configured to be disposed between a pair of adjacent furniture members or coupled to a wall. The storage apparatus comprises a base member comprising an upper member and a lower member, the upper and lower members slidably mounted together and adjusted to one of a plurality of locking positions to create a main cavity defined by space between the upper and lower members sufficiently large to secure the electronic device therein, the lower member comprising at least one opening configured to receive a head portion of the charging member to permit the head portion to be coupled to the secured electronic device, a first panel pivotably mounted to the lower member and configured to enclose the main cavity of the base member, and a second panel pivotably mounted to the lower member, wherein the second panel is configured to be disposed between the pair of adjacent furniture members or detachably coupled to the wall, thereby supporting the electronic device and charging member head portion in a stationary position.

In certain embodiments, the electronic device storage apparatus is configured to secure the head portion of the charging member if it is disconnected from the electronic device. This prevents the head portion of the charging member from falling out of the electronic device storage apparatus.

### BRIEF DESCRIPTION OF THE FIGURES

The detailed description of some embodiments of the invention will be made below with reference to the accompanying figures, wherein the figures disclose one or more embodiments of the present invention.

FIG. 1 depicts a perspective view of certain embodiments of the electronic device storage apparatus shown in use;

FIG. 2 depicts a perspective view of certain embodiments of the electronic device storage apparatus;

FIG. 3 depicts a perspective view of certain embodiments of the electronic device storage apparatus;

FIG. 4 depicts a perspective view of certain embodiments of the electronic device storage apparatus;

FIG. 5 depicts a perspective view of certain embodiments of the electronic device storage apparatus;

FIG. 6 depicts a section view of certain embodiments of the electronic device storage apparatus taken along line 6-6 in FIG. 4;

FIG. 7 depicts a section view of certain embodiments of the electronic device storage apparatus taken along line 7-7 in FIG. 5;

FIG. 8 depicts a section view of certain embodiments of the electronic device storage apparatus taken along line 8-8 in FIG. 5;

FIG. 9 depicts a section view of certain embodiments of the electronic device storage apparatus taken along line 9-9 in FIG. 2 shown in an exemplary initial configuration;

FIG. 10 depicts a section view of certain embodiments of the electronic device storage apparatus shown in an exemplary secondary configuration;

FIG. 11 depicts a section view of certain embodiments of the electronic device storage apparatus shown in an exemplary tertiary configuration;

FIG. 12 depicts a perspective view of certain embodiments of the electronic device storage apparatus;

FIG. 13 depicts a perspective view of certain embodiments of the electronic device storage apparatus;

FIG. 14 depicts a section view of certain embodiments of the electronic device storage apparatus taken along line 14-14 in FIG. 3;

FIG. 15 depicts a perspective view of certain embodiments of the electronic device storage apparatus;

FIG. 16 depicts a perspective view of certain embodiments of the electronic device storage apparatus shown in an alternate use;

FIG. 17 depicts a section view of certain embodiments of the electronic device storage apparatus taken along line 17-17 in FIG. 16;

FIG. 18 depicts a section view of certain embodiments of the electronic device storage apparatus shown in an alternate use;

FIG. 19 depicts a perspective view of certain embodiments of the electronic device storage apparatus shown in an alternate use; and

FIG. 20 depicts a perspective view of certain embodiments of the electronic device storage apparatus.

### DETAILED DESCRIPTION OF CERTAIN EMBODIMENTS

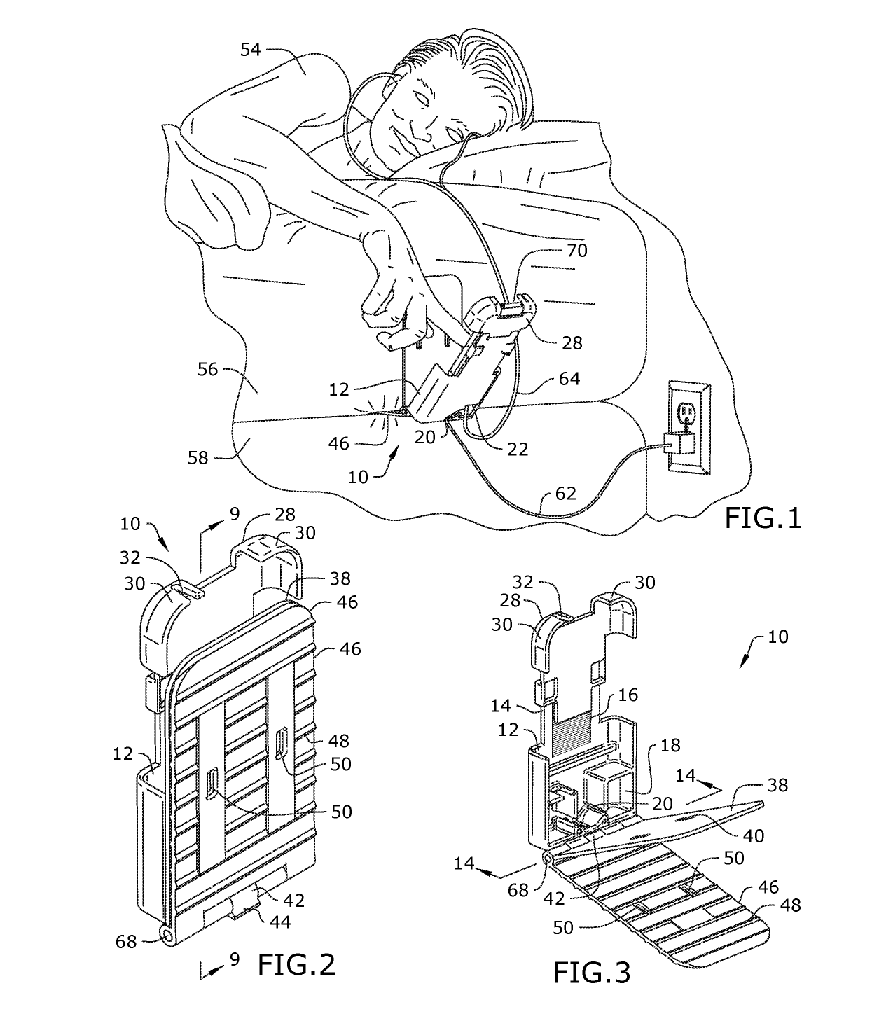

As depicted in FIG. 1-5, storage apparatus 10 is configured to secure electronic device 70, ear phone cord 64 and ear phone plug 66 when in use by operator 54. In one embodiment, storage apparatus 10 is secured to adjacent furniture members such as upper member 56 and lower member 58. Upper member 56 may be one of several items such as a mattress, sofa cushion, or the like. Lower member 58 may be one of several items such as a box spring, sofa body, or the like. It shall be appreciated that electronic device 70 may be any type of device including, but not limited to, a mobile phone, smartphone, tablet, phablet, baby monitor or alternate device.

Storage apparatus 10 generally comprises upper base member 28, lower base member 12, middle panel 38 and outer panel 46. Upper base member 28 comprises retainer arms 30, retainer arm slot 32 and side arms 34. Lower base member 12 comprises sliding tongue 14, sliding tongue grooves 16, storage compartment 18, slot 20 and slot enlargement portion 22.

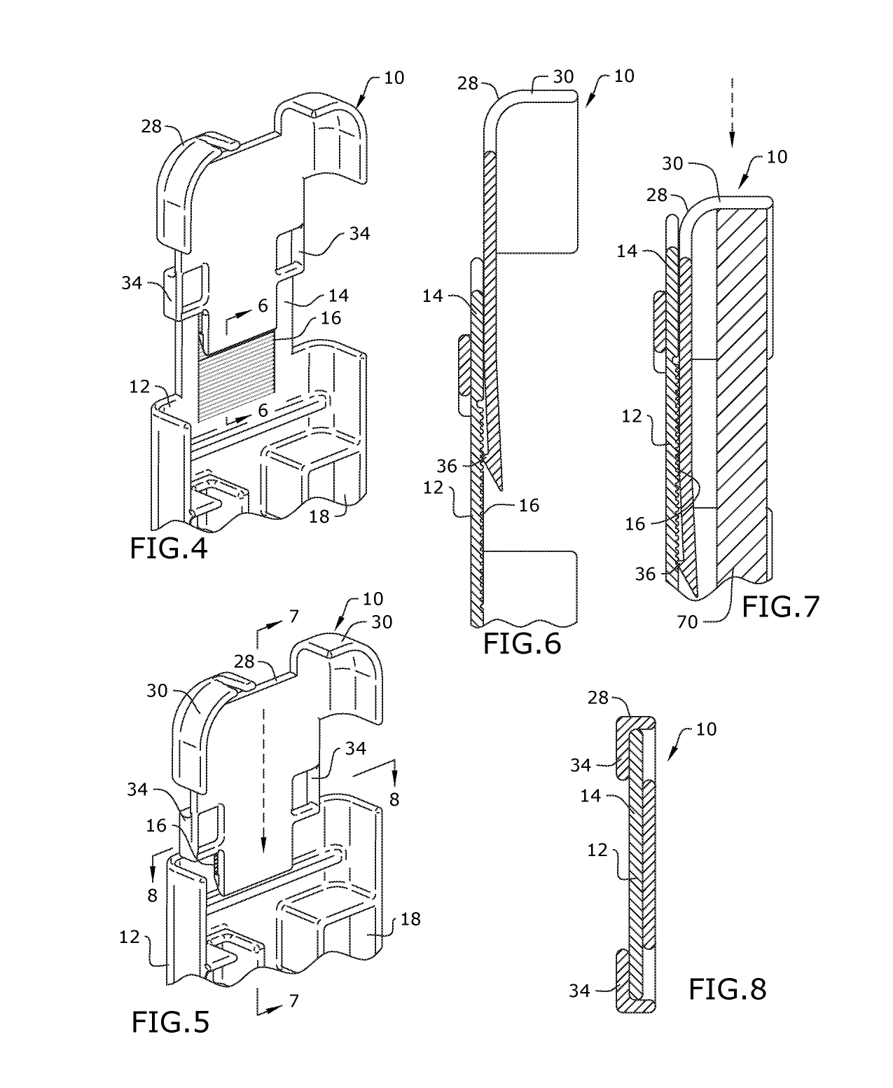

As depicted in FIGS. 4-7, upper base member 28 is slidably mounted to lower base member 12 to one of a plurality of locking positions to create a cavity sufficiently large to receive electronic device 70. More specifically, sliding tongue 14 of lower base member 12 is configured to slide within side arms 34 of upper base member 28 as depicted in FIG. 8. As upper base member 28 slidably adjusts relative to lower base member 12, sliding tooth 36 of upper base member 28 is configured to slide along sliding tongue grooves 16 of lower base member 12 until sliding tooth 36 engages with one of sliding tongue grooves 16. In a preferred embodiment, each groove of sliding tongue grooves 16 is oriented generally parallel to the other grooves. This makes it easier for sliding tooth 36 to slide along sliding tongue grooves 16. Once sliding tooth 36 engages with one of sliding tongue grooves 16, upper and lower base members 28, 12 are secured in a locked position.

FIGS. 4 and 6 depict upper and lower base members 28, 12 secured in a first configuration to receive a larger electronic device 70. FIGS. 5 and 7 depict upper and lower base members 28, 12 secured in a second configuration to receive a smaller electronic device 70. It shall be appreciated that upper and lower base members 28, 12 can be easily adjusted to alternate configurations to accommodate different sized electronic devices 70. A user (not shown) adjusts upper and lower base members 28, 12 by pushing or pulling the components.

As depicted in FIGS. 2-3 and 14, middle panel 38 and outer panel 46 are both pivotably mounted to lower base member 12 by hinge components. Specifically, middle panel 38 comprises middle panel hinge protrusion 42. Outer panel 46 comprises a pair of outer panel hinge arms 52. Lower base member 12 comprises a pair of lower base member hinge arms 24. Lower base member hinge arms 24, middle panel hinge protrusion 42 and outer panel hinge arms 52 are aligned together and each comprises a central opening configured to receive hinge pin 68 therethrough. Hinge screw 80 is coupled to the end of hinge pin 68 to secure the components together. In this configuration, middle panel 38 and outer panel 46 can each pivot relative to upper and lower base members 28, 12. Screw 80 may be rotated to tighten or loosen to adjust the tension and overall resistance present within lower base member hinge arms 24, middle panel hinge protrusion 42 and outer panel hinge arms 52.

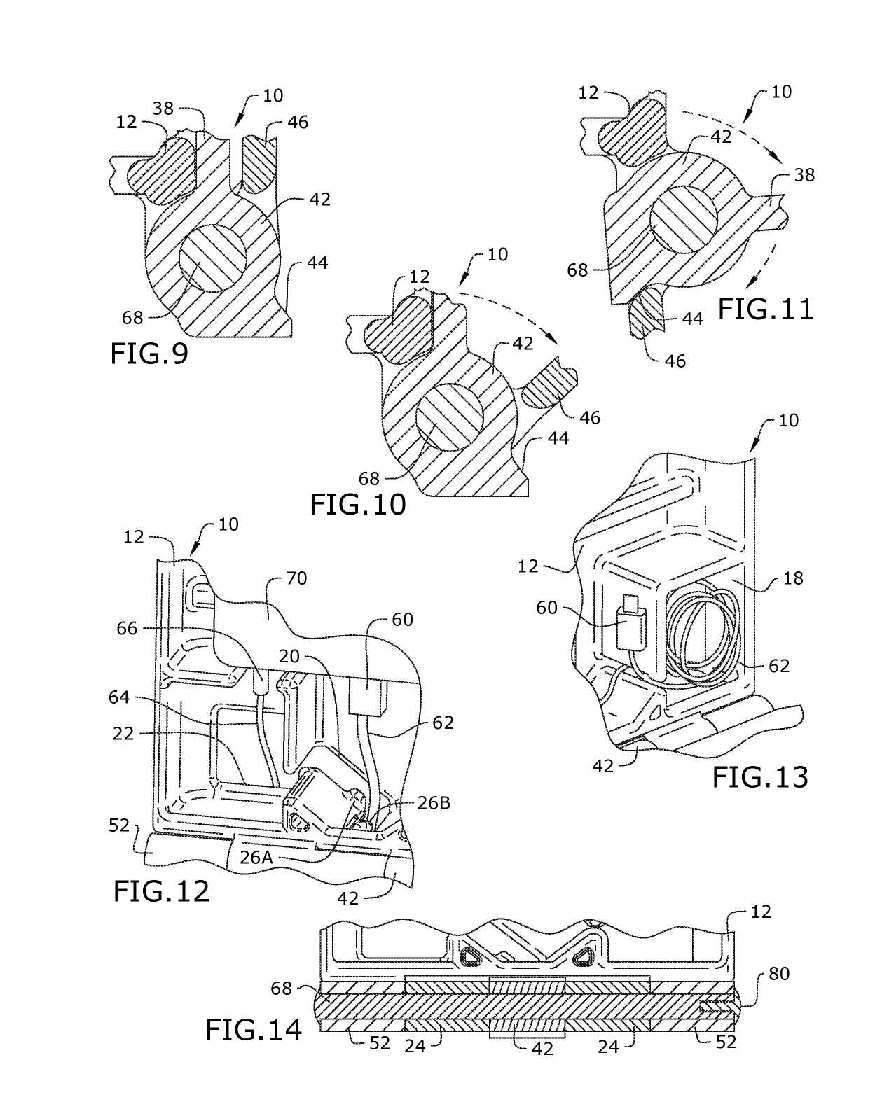

FIGS. 2 and 9 depict middle panel 38 and outer panel 46 adjusted to a compact configuration against upper and lower base members 28, 12. FIG. 10 depicts a pivotal adjustment of outer panel 46 relative to upper and lower base members 28, 12. FIG. 11 depicts the pivotal adjustments of both middle panel 38 and outer panel 46 relative to upper and lower base members 28, 12. Middle panel hinge protrusion 42 comprises stopper arm nub 44 to prevent outer panel 46 from rotating more than 90 degrees relative to middle panel 38.

In a preferred embodiment, middle panel 38 comprises middle panel fastener slots 40 and outer panel 46 comprises outer panel fastener slots 50. Middle panel fastener slots 40 and outer panel fastener slots 50 are configured to receive mechanical fasteners to mount storage apparatus 10 to a flat surface such as a wall. In one embodiment, outer panel 46 comprises outer panel teeth 48, which are configured to increase grip between outer panel 46 and adjacent furniture members as depicted in FIG. 1.

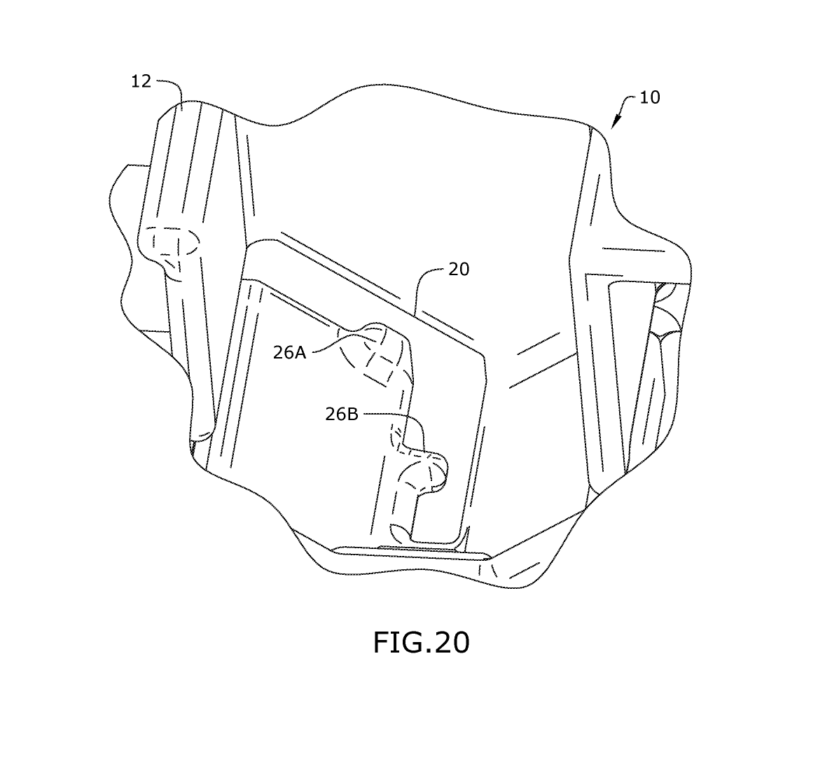

As depicted in FIGS. 12 and 20, slot 20 and slot enlargement portion 22 form a continuous opening in lower base member 12. More specifically, slot enlargement portion 22 is disposed through the back face of lower base member 12 and connects continuously to slot 20. Slot 20 extends diagonally through the back face of lower base member 12 and continues continuously into a bottom face of lower base member 12. First slot protrusion 26A and second slot protrusion 26B are coupled to lower base member 12 and situated proximate slot 20.

As depicted in FIG. 12, charging plug 60 and charging cord 62 are configured to couple to electronic device 70 in the secured position. In order to achieve this position, charging plug 60 and charging cord 62 are inserted through slot enlargement portion 22 from the outside of lower base member 12. Charging plug 60 and charging cord 62 are maneuvered sideways through slot 20 of lower base member 12 to permit charging plug 60 to connect with electronic device 70. In this position, charging cord 62 extends generally vertically out the portion of slot 20 located on the bottom face of lower base member 12. The remaining portion of charging cord 62 outside of storage apparatus 10 is then connected to an outside power source such as a power outlet.

If charging plug 60 comprises a larger sized head portion, charging cord 62 is generally positioned to extend between first and second slot protrusions 26A, 26B as shown in FIG. 12 prior to exiting lower base member 12 through slot 20. If charging plug 60 comprises a smaller sized head portion, charging cord 62 is generally positioned to extend around second slot protrusion 26B on the side away from first slot protrusion 26A (not shown). In these configurations, slot protrusions 26 are configured to retain charging plug 60 within lower base member 12 if disconnected from electronic device 70. This prevents charging plug 60 and charging cord 62 from falling outside of storage apparatus 10.

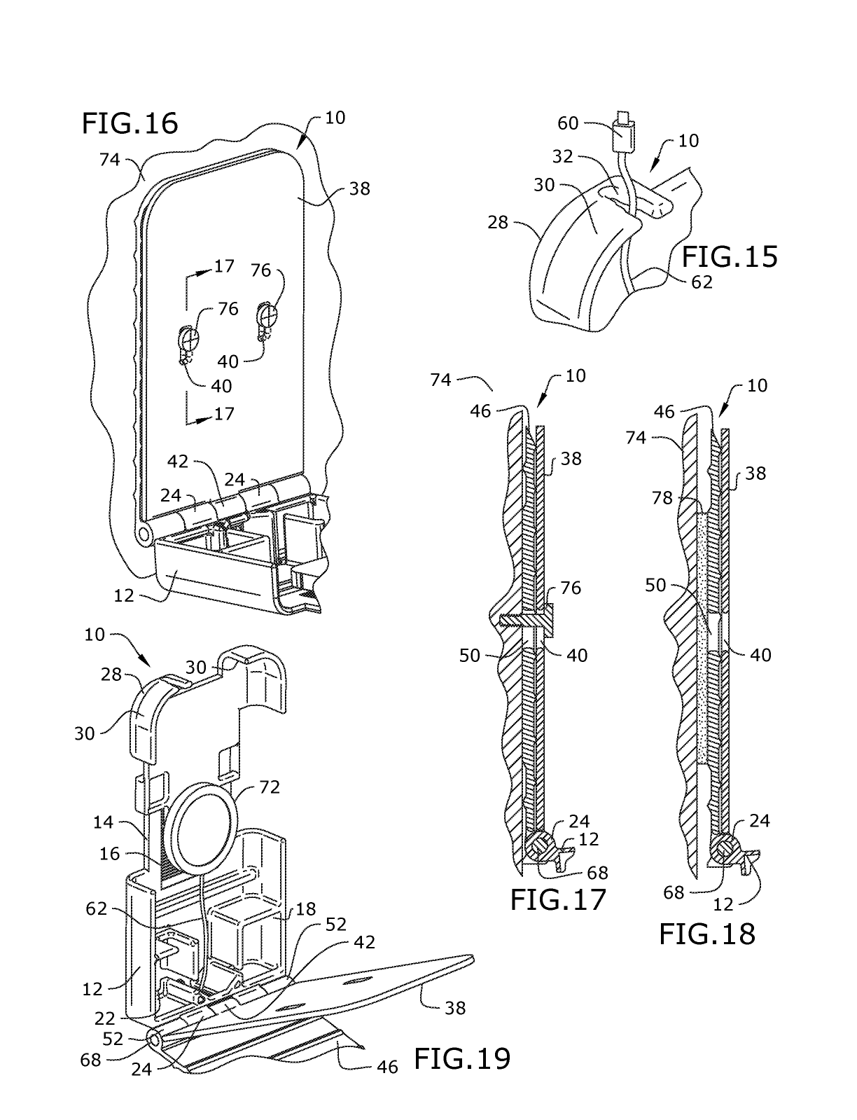

It shall be appreciated that storage apparatus 10 comprises several additional advantages. As depicted in FIG. 12, ear phone plug 66 and ear phone cord 64 can be connected to electronic device 70. Ear phone cord 64 can be maneuvered to extend out slot enlargement portion 22 of lower base member 12 to connect earpiece members to operator 54 as shown in FIG. 1. As depicted in FIG. 13, excess portions of charging cord 62 can be stored within storage compartment 18 of lower base member 12 as desired. As depicted in FIG. 15, charging plug 60 and charging cord 62 may be disposed through retainer arm slot 32 of upper base member 28 to permit electronic device 70 to be removed from storage apparatus 10. In this position, charging cord 60 will remain in place if electronic device 70 is removed from charging cord 60.

In operation, electronic device 70, charging cord 62 and ear phone cord 64 are secured within storage apparatus 10. As depicted in FIG. 1, middle panel 38 and outer panel 46 may be pivotably adjusted to help secure storage apparatus 10 to adjacent furniture members. Specifically, outer panel 46 is disposed between the furniture members such as upper member 56 and lower member 58. In this secured configuration, operator 54 can continue to use electronic device 70, charging cord 62 and ear phone cord 64 as needed.

In an alternative embodiment, storage apparatus 10 may be mounted to wall 74 as depicted in FIGS. 16-17. In this embodiment, mechanical fasteners 76 are inserted through middle panel fastener slots 40, outer panel fastener slots 50 and wall 74. Alternatively, adhesive strip 78 may be used to secure storage apparatus 10 to wall 74 as depicted in FIG. 18. In an alternative embodiment, charging pad 72 such as a wireless charger may be secured to storage apparatus 10 as depicted in FIG. 19. Charging pad 72 may be secured to upper base member 28 by an adhesive. In this configuration, electronic device 70 (not shown) may be disposed on charging pad 72.

It shall be appreciated that the components of storage apparatus 10 described in several embodiments herein may comprise any known materials in the field and be of any color, size and/or dimensions. It shall be appreciated that the components of storage apparatus 10 described herein may be manufactured and assembled using any known techniques in the field.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. An electronic device storage apparatus to secure an electronic device and a corresponding charging member therein, the storage apparatus configured to be disposed between a pair of adjacent furniture members or coupled to a wall, the storage apparatus comprising:
a base member comprising an upper member and a lower member, the upper and lower members slidably mounted together and adjusted to one of a plurality of locking positions to create a main cavity defined by space between the upper and lower members sufficiently large to secure the electronic device therein, the lower member comprising at least one opening configured to receive a head portion of the charging member to permit the head portion to be coupled to the secured electronic device;
a first panel pivotably mounted to the lower member and configured to enclose the main cavity of the base member; and
a second panel pivotably mounted to the lower member, wherein the second panel is configured to be disposed between the pair of adjacent furniture members or detachably coupled to the wall, thereby supporting the electronic device and charging member head portion in a stationary position.

2. The electronic device storage apparatus of claim 1, wherein the upper member of the base member comprises a pair of arms positioned on opposing side edges of the upper member, the lower member of the base member comprises a tongue portion disposed within the pair of arms of the upper member.

3. The electronic device storage apparatus of claim 2, wherein the tongue portion of the lower member comprises a plurality of grooves, each groove of the plurality of grooves positioned generally parallel to the other grooves in the plurality of grooves.

4. The electronic device storage apparatus of claim 3, wherein the upper member of the base member comprises a tooth configured to engage with one of the plurality of grooves in the tongue portion to secure the upper and lower members of the base member in one of the locking positions.

5. The electronic device storage apparatus of claim 4, wherein the first and second panels each comprises at least one hinge component, the hinge components of the first and second panels being coupled together by a pin disposed therethrough.

6. The electronic device storage apparatus of claim 5, further comprising a screw coupled to the pin, wherein the screw is configured to adjust to create a desired level of tension present in the hinge components of the first and second panels.

7. The electronic device storage apparatus of claim 6, wherein the second panel comprises a plurality of panel teeth configured to enhance grip between the second panel and the pair of adjacent furniture members.

8. The electronic device storage apparatus of claim 7, wherein the lower member of the base member comprises a back face, side faces coupled to the back face, and a bottom face coupled to the back face and side faces, wherein the at least one opening is disposed through the back face and extends continuously to the bottom face.

9. The electronic device storage apparatus of claim 8, further comprising a pair of protrusions coupled to the lower member of the base member and positioned proximate the at least one opening, wherein each protrusion of the pair of protrusions is configured to retain a cord portion of the charging member.

10. The electronic device storage apparatus of claim 9, wherein the lower member of the base member comprises a compartment configured to store a portion of the cord portion of the charging member.
